(19) United States
(12) Patent Application Publication
(10) Pub. No.: US 2008/0022098 A1
(43) Pub. Date: Jan. 24, 2008

(54) Authentication process

(76) Inventors: Robert G. Muscat, Alpharetta, GA (US); James D. Chambers, Lawrenceville, GA (US)

Correspondence Address: JOHN S. PRATT - 38949;KILPATRICK STOCKTON LLP, 1100 PEACHTREE STREET, SUITE 2800, ATLANTA, GA, 30309, US

(21) Appl. No.: 11/510,056

(22) Filed: Aug. 25, 2006

Related U.S. Application Data
(63) Continuation-in-part of application No. 11/241,195, filed on Sep. 30, 2005.

(51) Int. Cl. H04L 9/00

(52) U.S. Cl. 713/168

(57) ABSTRACT

A process for authenticating products from a remote location using existing communication devices and communication networks is described. The process may comprise authentication information, a group identifier, and/or response code associated with a product. The process may provide for easy authentication of product from a remote location in a cost effective manner.

### CROSS REFERENCE TO RELATED APPLICATION

This application is a continuation-in-part of U.S. patent application Ser. No. 11/241,195, filed Sep. 30, 2005 for “Packaging and Process of Authenticating Packaging,” the entire contents of which are incorporated herein by reference.

### FIELD OF THE INVENTION

Certain embodiments of the present invention relate to authentication processes, and more specifically to processes that allow for remotely authenticating products via phone, email, Internet or any type of communication means.

### BACKGROUND

Technology advances and the lowering of trade barriers continually enhance the growing global economy. Such growth has led to increased traffic of consumer goods through international trade channels. However, with the increase of consumer goods traffic, problems have arisen with gray market goods, criminal subversion, and/or counterfeiting.

Often when crossing international borders, goods are stopped for inspection by local customs authorities. The United States Customs Department allows for U.S. registered trademark holders to record trademarks with the customs authority. When goods bearing the recorded mark or a mark substantially similar to the recorded mark enter the United States, they are stopped by the customs authority and inspected for authenticity. The sophistication of counterfeit goods and the existence of gray market goods and parallel imports has made it difficult for customs inspectors to determine which goods are authentic and which are not. Therefore, many manufacturers and trademark holders have turned to security measures associated with their product packaging and branding strategies to ensure authenticity of goods.

Recent methods of authentication and brand protection have focused on adding authentication mechanisms to existing product packaging. These attempts at authentication include the use of labels or seals that are applied to the product packaging containing a security identifier. One example of such a security mechanism is the use of a hologram as an identifier of authenticity. Holograms may be applied as an adhesive label to the product packages. The use of holograms, however, requires additional machinery that can add substantial cost to the product.

### SUMMARY

Certain embodiments of the present invention provide a process for verifying the authenticity of a product utilizing authentication information (such as, for example an alpha-numeric or other type of code) as well as a group identifier that is associated with the product (either directly on the product or indirectly via the product's packaging). According to certain embodiments, the authentication information can be randomly generated (such as a randomly generated code including letters, numbers, and/or symbols) as part of a plurality of randomly generated authentication codes stored in a central database maintained by an authentication authority. The group identifier, which may also be a randomly generated code including letters, numbers, and/or symbols may be associated with the generated authentication codes stored in the central database. The authentication code and group identifier associated with the product can be used by a user to verify the authenticity of the product.

The product may be distributed through the stream of commerce from the packaging facility to an end user. This may involve passing through customs if the product is being imported. A party, such as a customs agent or other user seeking to authenticate the package, may do so from a remote location according to certain aspects of the invention. The user may transmit the group identifier and authentication code associated with the product to the authentication authority. This may be done by telephone, facsimile, mobile phone, text messaging, electronic mail, secure web site or any other type of communication means. Once the authentication authority receives the group identifier and authentication code, the authentication authority may determine: if the group identifier matches a group identifier stored in the central database; if the authentication code corresponds to one of the authentication codes stored in the central database in connection with that group identifier; and if the authentication code has already been used more than the preset number of allowable times. If these conditions are satisfied, the authentication authority may inform the user that the product is authentic and may also update the central database to reflect that the authentication code has been used, and the date, time, recipient, or any other relevant information relating to the authentication process.

### BRIEF DESCRIPTION OF THE DRAWINGS

FIG. 1 is a flow chart schematically illustrating a process according to certain embodiments of the invention.

FIG. 1a is a flow chart schematically illustrating a process according to other embodiments of the invention.

FIG. 2 is a block diagram schematically illustrating data flow in accordance with some of the embodiments illustrated by FIG. 1.

FIG. 3 is a flow chart schematically illustrating a process according to other embodiments of the invention.

FIG. 4 is a block diagram schematically illustrating data flow in accordance with some of the embodiments illustrated by FIG. 3.

### DETAILED DESCRIPTION

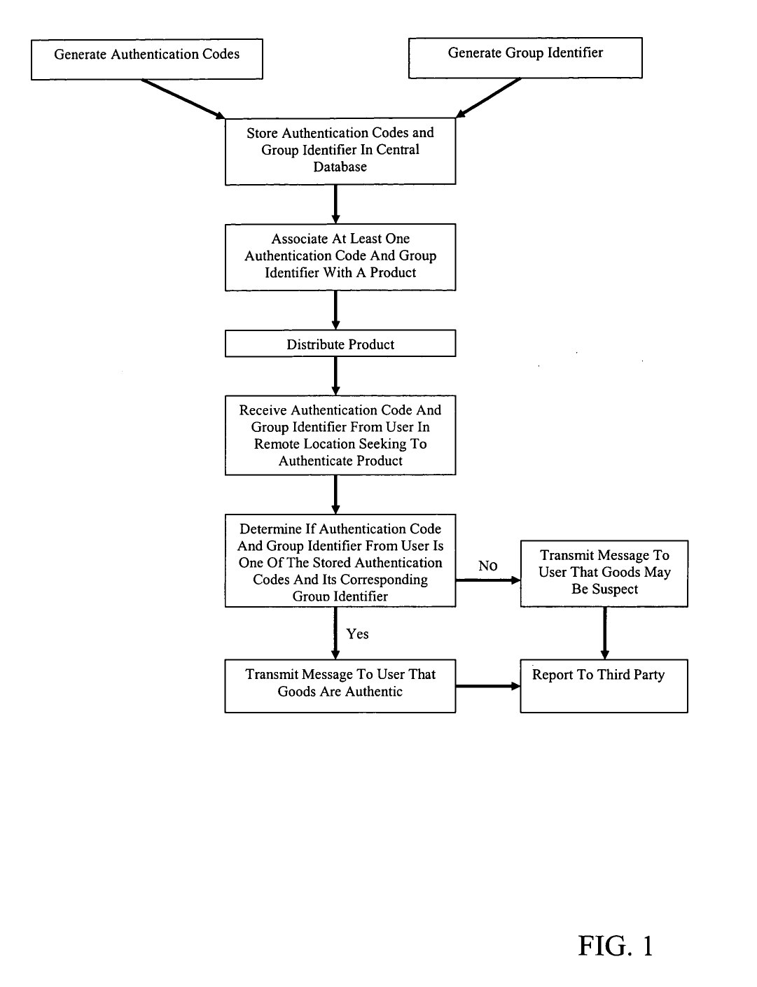

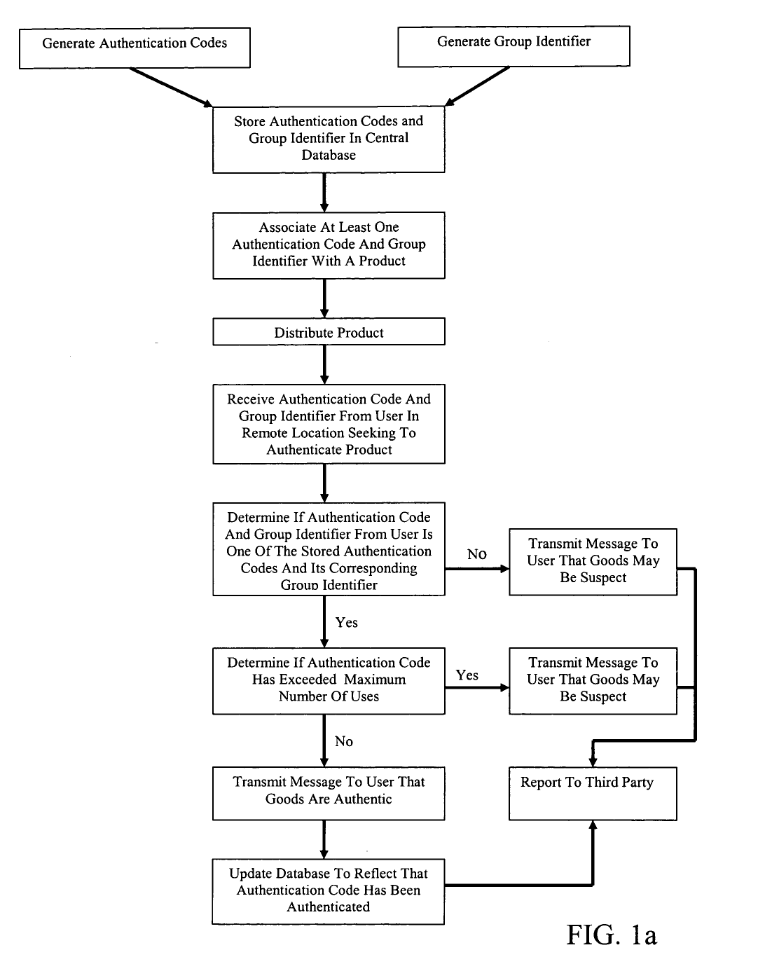

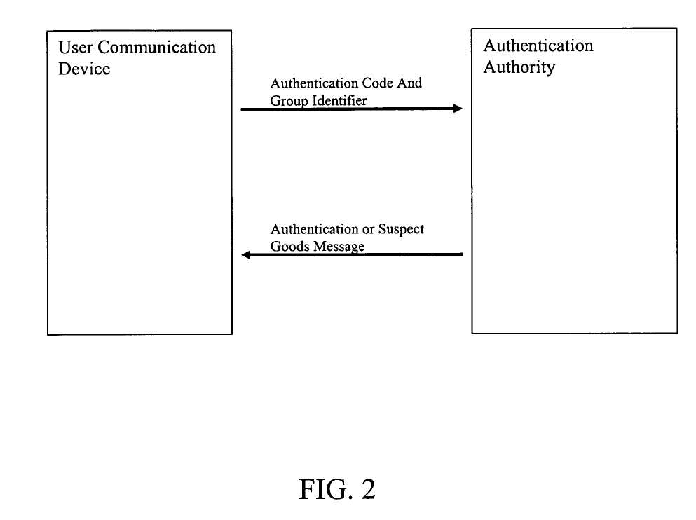

FIGS. 1 and 2 schematically illustrate an authentication process according to some embodiments of the present invention. As shown in FIG. 1, a user desiring to authenticate a product transmits authentication information (such as an authentication code, token code, or other type of information) and group identifier (which may be referred to as a key code or by another name) associated with the product to an authentication authority. Upon receipt of the authentication code and group identifier, the authentication authority may reply back to the user, stating whether the product is authentic or suspect, and may also take other actions. Such a system may allow a user to quickly and easily confirm whether a product is authentic.

In the embodiments schematically illustrated in FIG. 1, the process begins with the generation of authentication codes and group identifier(s). The authentication code may be a multi-character code composed of one or both of letters and numbers, or other types of symbols. In some embodiments, the authentication code is a randomly generated 8 character code comprised of the numbers 0 through 9 and/or the letters A through Z in the English alphabet. Alphabets from other languages, other numbering systems, or other symbols may be used for the authentication code if desired.

The group identifier may be generated in a similar manner as the authentication code. In some embodiments, the group identifier is a randomly generated 6 character code composed of the numbers 0 through 9 and/or the letters A through Z in the English alphabet. In other embodiments, other languages, numbering systems, or other symbols may be used for the group identifier if desired.

The group identifier and authentication codes may be at least temporarily stored in a central database. The database may include a list of authentication codes and the group identifier that the authentication codes correspond to. In some embodiments, the database may store numerous group identifiers, each having its own corresponding list of authentication codes. The central database may also maintain additional information about the products associated with those authentication codes and group identifiers. For instance, in some embodiments, the central database may maintain information on the products' type, brand, quantity, color, ship date, intended destination, pricing, manufacturing location or any other information that is associated with product(s) of a certain authentication code and/or group identifier. In some embodiments, other information may also be maintained in the central database, such as the number of times the authentication code has been used to authenticate a certain product, an expiration date for the authentication code, or other information. Some of these embodiments are discussed in additional detail below. In some embodiments, the central database may be a secure database that prevents unauthorized access to the information stored therein.

The central database may be maintained by an authentication authority. In some embodiments, the authentication authority may be the product manufacturer, distributor, retailer, or other entity associated with the product. In other embodiments, however, the authentication authority may be a third-party that does not have any direct connection to the product. The authentication authority may be the same entity that generates the group identifiers and authentication codes, or it may receive the authentication codes and group identifiers from another party (whether through electronic, hard copy, or some other means).

As schematically illustrated in FIG. 1, an authentication code and group identifier may be associated with the product to be authenticated. In some embodiments, the authentication code and group identifier are printed on the product's packaging to associate them with the product. In other embodiments, the authentication code and group identifier are printed directly on the product or on a label associated with the product. Other methods and techniques may be used in addition to or in lieu of these methods. In these or other embodiments, one or more bar codes may be employed in lieu of, or in addition to, the printed group identifiers and authentication codes to incorporate bar code readers into the authentication process. In other embodiments, other methodologies, including but not limited to molding or stamping, may be employed to associate the product with the authentication code and group identifier.

In accordance with the embodiments schematically illustrated in FIG. 1, once the products (associated with authentication codes and group identifiers) enter the distribution chain, various users (whether they be individuals or other entities) may check and confirm the authenticity of the products. Authenticity may be confirmed by distributors, wholesalers, retailers, customs agents, customers, or other users who come into contact with the products.

FIG. 2 schematically illustrates the information flow between the user and the authentication authority according to some embodiments of the invention. As shown in FIG. 2, a user may begin the authentication process by transmitting one or both of the group identifier and authentication code associated with the product to the authentication authority. The authentication authority may be an automated response system, a voice recognition system, a live telephone operator, or another type of system for responding to users' authentication requests.

The transmission may take place by telephone, cellular phone, text message, electronic mail, network connection, accessing an Internet web site, by a combination of these methods, or by another method. Depending on the methodology used to contact the authentication authority, a phone number, web-site address, or other contact information may be associated with the product to inform the user how to authenticate the product. In other embodiments, no indication (other than the authentication code and group identifier) is given as to how to authenticate the product and the user will be expected to already know how to contact the authentication authority to authenticate the product.

The user may transmit the group identifier and authentication code at the same time or at separate times. In some embodiments, the user will first enter the group identifier, and wait for the authentication authority to confirm that the group identifier is valid (or wait for the authentication authority to request the authentication code). In such embodiments, the authentication authority may first compare the provided group identifier to the one or more group identifiers stored in the central database to confirm whether the provided group identifier is valid. If the provided group identifier does not correspond to any of the group identifiers stored in the central database, or if the provided group identifier is otherwise indicated in the central database as being invalid, the authentication authority may inform the user that the product's authenticity is suspect, and may or may not provide the user with an opportunity to re-enter the group identifier. Alternatively, the authentication authority may request the user to re-enter the group identifier. The authentication authority may also check whether additional pertinent information is associated with the provided group identifier, such as recall notifications, use-by deadlines, or other information. This additional information may or may not be shared with the user by the authentication authority.

In some embodiments, after the group identifier is confirmed, the authentication authority may request the authentication code (if not already provided) and may check to see if the authentication code matches an authentication code stored in the central database in connection with the already confirmed group identifier. (In other embodiments, the authentication code can be checked first, before the group identifier.) If the authentication code provided matches one in the central database for the group identifier, the authentication authority may inform the user that the product is authentic.

Alternatively, in some embodiments, such as the embodiments shown in FIG. 1a, the authentication authority may check the central database to see if the provided authentication code has been authenticated previously on one or more occasions. In such embodiments, if the authentication code has been authenticated more than the authorized number of times, the authentication authority may inform the user that the product is suspect. For instance, if, in some embodiments, the central database indicates that a authentication code may be authenticated twice (e.g., once for the distributor and once for the retailer) and that the authentication code has already been provided and authenticated twice, upon receiving the authentication code for a third time, the authentication authority may inform the user that the product is suspect. In other embodiments, after the authentication code has been used a pre-determined number of times, that particular authentication code may simply be removed from the central database, such that it will not be a valid authentication code any longer. In some embodiments, removing (or de-authorizing) one or more authentication codes (individual codes, sub-groups of codes corresponding to a group identifier, or even an entire group or groups of authentication codes) may be done manually if desired (in response to, for instance, theft of a particular shipment of product). In still other embodiments, authentication codes may be automatically removed or de-authorized if a “use-by” date or other deadline passes. In these or other embodiments, similar procedures may be followed to remove or de-authorize group identifiers.

Thus, invalid authorization codes may include authorization codes that were never in the central database, authorization codes that have already been used more than a pre-set allowable number of times, authorization codes that have been removed either automatically or manually from the database, authorization codes that have been flagged for other reasons (e.g., the expiration of a “use-by” date), or other authorization codes that do not correspond to authentic products or have otherwise been de-authorized. If the authentication authority determines the goods are suspect, the authentication authority may transmit this information to the user along with instructions regarding how to handle the suspect goods, including but not limited to, shipping or refund information.

As shown in embodiments illustrated by FIG. 1a, the authentication authority may update the central database to reflect that an authentication event has happened for a particular group identifier/authentication code combination. As discussed above, this may be done to lessen the chances that a counterfeiter or the like could copy a group identifier authentication code combination and use the same combination on a number of counterfeit goods. Also, recording this information may also, in some embodiments, facilitate the preparation of real-time or periodic reports for use by the authentication authority, the manufacturer, brand owner, distributor, retailer or other individual or entity associated with the product. Such reports may also provide other information, such as the number of suspect authentication events, geographic distribution of products being authenticated, method of authentication, identity of person authentication product, or other information tracked in the central database. These reports may be provided simultaneously with the authentication event, or may be provided periodically, on a daily, weekly, monthly, yearly, or other basis.

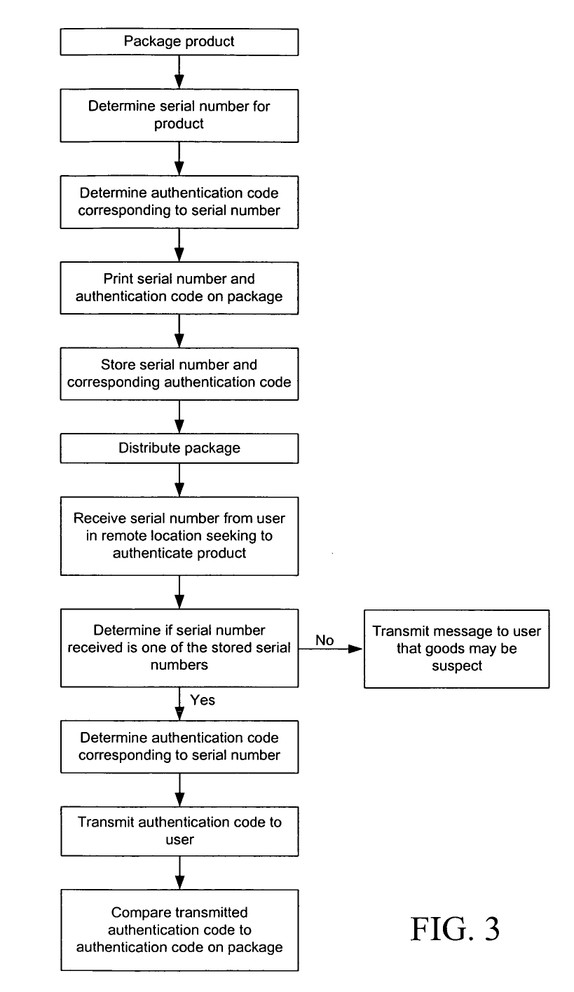

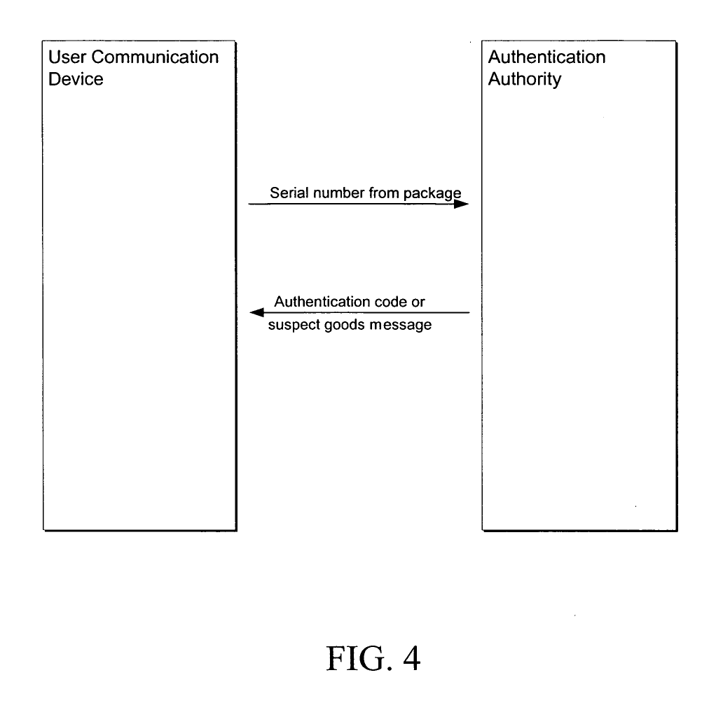

FIGS. 3 and 4 schematically illustrate other embodiments of the present invention. In the embodiments shown in FIGS. 3 and 4, products may be packaged in a product packaging of some type containing an authentication code (with or without a group identifier). In some of the embodiments illustrated by FIGS. 3 and 4, the person desiring to determine if a product is authentic may call an authentication authority and provide the authentication code. In these embodiments, the authentication authority may respond by providing a response code. The user receiving the response code information may then compare the response code to a response code printed on the product or its associated packaging, which may be obscured by a coin abrasive covering if desired. If the response codes match, the goods can be identified as authentic. Alternatively, if the codes do not match, the goods may be identified as suspect.

In the embodiments illustrated in FIGS. 3 and 4, once the authentication code for a product has been generated, it may be preferable to generate a response code for each authentication code. The response code may be generated by the packaging facility, a third party (subsequently transmitted to the packaging facility) or by any other entity. Each authentication code may correspond to a single response code. The response code may be printed on the packaging (or otherwise associated with the product) and covered by a coin abrasive substance or a chemical treatment obscuring the response code from view if desired. The chemical treatment may be a treatment of ink that when exposed to air or light will react and darken after a short period of time. The response code may be covered by a protective cover which when removed allows the user to see the code for a brief amount of time prior to the reaction that caused the area to darken and the code to become unreadable. The response code may be a random collection of alpha, numeric, and/or symbolic characters or may be a word or a phrase if desired.

In some embodiments (including but not limited to some embodiments corresponding to one or both of FIGS. 1 and 3), the authentication code associated with the product may be different for each product or alternatively the same authentication code may be placed on a batch of products if desired. For example, the same authentication code may be associated with all products packaged on a particular day and a different authentication code used for products packaged on each different day if desired. It should be understood that an authentication code may be associated with product packaging in any incremental batch as desired (or unique to each product).

In accordance with some of the embodiments of the invention, the product associated with the authentication code, group identifier, and/or response code may be distributed according to its usual supply chain. A user, such as a customs agent or a purchaser of the product, wishing to determine if the product is authentic may do so from a remote location using existing communication lines and communication devices.

In the embodiments illustrated in FIGS. 1-4, or in other embodiments, the party wishing to authenticate the product may do so over any desired communication lines, such as landline, mobile and cellular phones, SMS text messaging, networked computer systems, web based systems, secure web sites and others. The authentication may be done using a telephone, facsimile, cell phone, pager, text messenger, personal computer, lap top, PDA, Blackberry, portable e-mail devices, or any other communication device. It should be understood that in some embodiments the response to the party wishing to authenticate (whether it is an indication of whether the product is authentic or a response code) may be transmitted to the user by a different communication means than that used by the user when transmitting the authentication code or other information to the authentication authority if desired.

According to certain embodiments of the invention, the authentication authority may preferably transmit more information than just the response code or indication of authenticity to the user. For example, the authentication authority may also transmit the product name, place of manufacture, date of manufacture, shipping destination and any other information if desired. It should also be understood that the authentication authority may transfer additional information if the information provided by the user is invalid. For example, the authentication authority may provide instructions of what to do with a suspect product. Certain embodiments of the invention may only allow authentication of the product one time. Alternatively, certain embodiments of the invention may allow for the product to be authenticated multiple times if desired.

According to certain embodiments of the invention, a product may be required to be authenticated multiple times along the distribution chain from manufacturing facility to end customer. In some of the embodiments in accordance with FIGS. 1-2 or FIGS. 3-4, there may be multiple authentication codes, group identifiers and/or response codes associated with each product. For example, if the product is to be authenticated by customs officials upon entry into the United States and by the consumer, the authentication codes, group identifiers, and/or response codes for use by the customs officials may be different from the authentication codes, response codes, and/or group identifiers used by the retailer and/or consumer. In such a case, the customs officials should be told where to find the relevant information on the packaging either in advance or by the authentication authority. Similarly, the retailer and/or consumer may be told where to locate the appropriate information on the package. In other embodiments, all the users could use the same codes and identifiers.

While this invention has been described in detail with particular reference to the disclosed embodiments, it will be understood that variations and modifications can be affected within the spirit and scope of the invention as described herein and as defined in the appended claims.

1. A process for verifying the authenticity of a product, comprising:
(a) generating a plurality of authentication information and assigning the plurality of authentication information to a group identifier;
(b) at least temporarily storing the plurality of authentication information and group identifier in a central database;
(c) associating at least one of the generated authentication information and the group identifier with a product;
(d) distributing the product;
(e) receiving the authentication information and group identifier associated with the product from a user located remotely from the central database;
(f) determining whether the authentication information and group identifier provided by the user match the authentication information and the group identifier stored in the database; and
(g) transmitting a message to the user regarding the authenticity of the product.

2. The process for verifying the authenticity of a product of claim 1, wherein generating a plurality of authentication information comprises randomly generating a plurality of authentication codes.

3. The process for verifying the authenticity of a product of claim 2, wherein assigning the authentication codes to a group identifier comprises assigning the authentication codes to a randomly generated group identifier.

4. The process for verifying the authenticity of a product of claim 1, further comprising:
(a) receiving invalid authentication information associated with an unauthorized product from the user;
(b) comparing the invalid authentication information to the plurality of authentication information and the group identifier stored in the database; and
(c) indicating to the user that the authenticity of the unauthorized product is suspect.

5. The process for verifying the authenticity of a product of claim 4, further comprising reporting to a third party the receipt of the invalid authentication information.

6. The process for verifying the authenticity of a product of claim 1, further comprising recording in the central database that the authentication information associated with the product has been authenticated.

7. The process for verifying the authenticity of a product of claim 1, further comprising removing the authentication information associated with the product from the central database after indicating to the user that the product is authentic.

8. The process for verifying the authenticity of a product of claim 1, further comprising recording in the central database the expiration of at least some of the plurality of authorization information after a certain period of time.

9. The process for verifying the authenticity of a product of claim 1, further comprising storing in the central database additional information about the product associated with the authentication information.

10. The process for verifying the authenticity of a product of claim 1, wherein receiving the authentication information and group identifier further comprises receiving the authentication information and group identifier over a phone call.

11. The process for verifying the authenticity of a product of claim 1, wherein receiving the authentication information and group identifier further comprises receiving the authentication information and group identifier over an Internet connection.

12. The process for verifying the authenticity of a product of claim 1, wherein receiving the authentication information and group identifier further comprises receiving the authentication information and group identifier via an electronic interface.

13. The process for verifying the authenticity of a product of claim 1, wherein associating the at least one of the generated authentication information and the group identifier with the product further comprises associating at least one bar code corresponding to the at least one authentication information and the group identifier with the product.

14. The process for verifying the authenticity of a product of claim 1, further comprising reporting to a third-party information regarding authentication of the product.

15. A process for verifying the authenticity of a product, comprising:
(a) generating a plurality of authentication information and assigning the plurality of authentication information to a group identifier;
(b) at least temporarily storing the plurality of authentication information and group identifier in a central database;
(c) associating at least one of the generated authentication information and the group identifier with a product;
(d) distributing the product;
(e) receiving the authentication information and group identifier associated with the product from a user located remotely from the central database;
(f) determining whether the authentication information and group identifier provided by the user match the authentication information and the group identifier stored in the database;
(g) transmitting a message to the user regarding the authenticity of the product; and
(h) recording in the central database that the authentication information associated with the product has been authenticated.

16. The process for verifying the authenticity of a product of claim 15, further comprising removing the authentication information from the central database after indicating to the user that the product is authentic.

17. The process for verifying the authenticity of a product of claim 15, further comprising removing the authentication information from the central database after receiving the authentication information and group identifier associated with the product a plurality of times.

18. The process for verifying the authenticity of a product of claim 15, further comprising recording in the central database the expiration of at least some of the plurality of authorization information after a certain period of time.
